(19) United States
(12) Patent Application Publication
(10) Pub. No.: US 2002/0104565 A1
(43) Pub. Date: Aug. 8, 2002

(54) CGA fitting restraint device for liquid cylinder

(76) Inventors: William Haukoos, Waleska, GA (US); Thomas Carey, Woodstock, GA (US)

Correspondence Address: CALFEE HALTER & GRISWOLD, LLP, 800 SUPERIOR AVENUE, SUITE 1400, CLEVELAND, OH, 44114, US

(21) Appl. No.: 10/068,748

(22) Filed: Feb. 5, 2002

Related U.S. Application Data
(60) Provisional application No. 60/266,579, filed on Feb. 5, 2001.

(51) Int. Cl. F16K 27/08

(52) U.S. Cl. 137/382

(57) ABSTRACT

A bracket assembly for securing a fitting to a liquid cylinder within the Compressed Gas Association standards for the industrial gas industry. The tamper resistant bracket prevents a fitting from being removed from and an incorrect fitting from being attached to a liquid cylinder so as to not to provide the wrong product for a given application.

### PRIORITY CLAIM

This application claims the benefit of U.S. provisional patent application No. 60/266,579 filed on Feb. 5, 2001, the entirety of which is hereby incorporated by reference.

### FIELD OF THE INVENTION

The present disclosure relates to a safety improvement for use in connection with fittings, and more specifically, a fitting restraint device for a liquid cylinder.

### BACKGROUND OF THE INVENTION

The improvement relates to the industrial gas industry. The Compressed Gas Association (CGA) publishes a wide variety of standards for the industrial gas industry. The publications provide standards for compressed gas cylinder valve outlet and inlet connections. The primary services for liquid cylinders are liquid nitrogen, oxygen, argon, carbon dioxide and nitrous oxide, which are very dangerous when mishandled.

Hoses for filling and discharging a product are frequently attached to and removed from the CGA fittings. It is possible for an untrained or uninformed user to change valve connections by simply unthreading the exit fitting and threading in a different fitting. For example, it is possible to remove an oxygen service fitting and replace it with an nitrogen service fitting. The consequence of this incorrect fitting replacement is the supply of oxygen to an nitrogen application.

The CGA has revised Safety Bulletin 26 (SB-26-2001) so that tamper-resistant devices are required on medical gas cylinders and tamper-evident devices are required on industrial gas cylinders. Tamper-resistant devices can be silver brazed, welded or attached by other methods in a manner that prevents removal or would render the connection or valve body outlet unusable if removal was attempted. The current industry standard fitting restraint device is a cable that wraps around the valve body and attaches to a ring with a plastic clasp. This device is more tamper-evident and not tamper-resistant as required by the CGA.

As compared to the prior art, a significant difference between the present invention and the prior art is the type of attachment to the valve body. The present invention device is installed in a secure manner and includes devices such as rivets which allow disassembly of the invention, but only with a great degree of effort.

### SUMMARY OF THE INVENTION

The present invention is directed to a safety bracket system involving fittings and liquid cylinders that satisfies the need to prevent against mixing gases.

In one aspect, the invention provides a bracket for preventing undesired movement of a storage cylinder fitting which includes a lower section permanently mounted to a storage cylinder, an upper section affixed to the lower section where the upper section defines an interference surface for abutting against the storage cylinder fitting to prevent rotational movement thereof.

In another aspect, the invention provides a bracket for preventing undesired manipulation of a storage cylinder fitting attached to a storage cylinder valve, the bracket including a horizontal section defining an opening through which a valve body of the storage cylinder valve extends, a vertical section including an interference surface for abutting against the storage cylinder fitting to prevent rotational movement thereof; and locking means for restraining lateral movement of the vertical section.

In yet another aspect, the invention provides a bracket for preventing undesired manipulation of a storage cylinder fitting attached to a storage cylinder valve, the bracket includes a vertical section with an exterior plate and an interior plate and means for attaching the two. The exterior plate includes an interference surface for abutting against the storage cylinder fitting to prevent rotational movement thereof, and a horizontal section integrally formed with the interior plate wherein the horizontal section circumscribes a valve body of the storage cylinder valve.

The present invention provides may advantages over what is known. The bracket described is difficult to tamper with, but may be removed with the right tools and patience. The bracket described is also reusable by installing new locking devices into the existing bracket pieces. The invention is provided in both an original equipment version where a weld joint to a storage cylinder is used and a retrofit version where contact with the storage cylinder is not required. The invention provides a bracket which minimizes the ability tamper with a storage cylinder by removing its fitting, and also prevents normal loosening and/or unthreading of the fitting which may occur in normal usage. Thus, the potential for leaks is minimized.

### BRIEF DESCRIPTION OF THE DRAWINGS

FIG. 1 is a perspective view of the first embodiment of the present invention;

FIG. 2 is an exploded view of the first embodiment;

FIG. 3 is a perspective view of a variation of the first embodiment;

FIG. 4 is a front view of a portion of the first embodiment;

FIG. 5 is an exploded view of a fitting and a valve;

FIG. 6 is a perspective view of a second embodiment of the present invention;

FIG. 7 is a side view of the second embodiment;

FIG. 8 is a perspective view of a part of the second embodiment; and

FIG. 9 is a perspective view of a part of the second embodiment.

### DETAILED DESCRIPTION

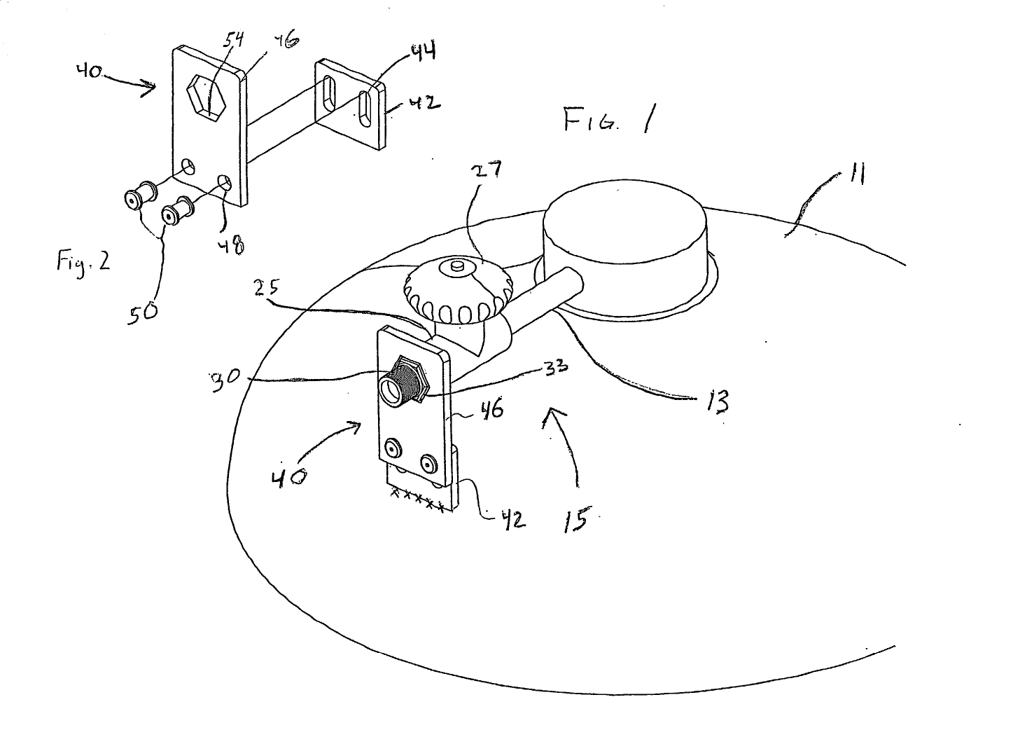

The invention will now be described with reference to the drawings. FIG. 1 shows a piping connection 15 for a tank or cylinder 11 with a bracket 40 which protects the piping connection from undesired manipulation. The piping connection 15 has a first pipe 13 with one end attached to the cylinder 11. The opposite end of the first pipe 13 is attached to a valve 25. The valve contains a removable handle 27 to open and close the valve 25.

Referring to FIG. 5, a fitting 30 with external threads 34 fits into the valve 25 with internal threads 26. The fitting 30 is specific as to the type of gas or liquid which is to be transferred in or out of the cylinder. The fitting 30 is cylindrical in shape with a first end 31, a second end 32, and a midsection 33. The first end 31 is externally threaded in order to attach to the valve 25. This first end 31 has the same thread type for all the different fittings. The midsection 33 is preferably shaped like a hexagonal nut, including wrench flats, in order for a wrench to grasp the fitting 30 and twist the fitting 30 on or off the valve 25. The second end 32 is externally threaded, but the type varies depending upon which type of gas is distributed from the cylinder.

Referring to FIGS. 1 and 2, a first embodiment of the bracket 40 comprises a lower section 42 and an upper section 46. The lower section 42 contains slotted holes 44 and is welded to the top of the cylinder 11 in order to prevent easy removal of the bracket 40 and manipulation of the storage cylinder fitting 30. The holes 44 may also be circular as opposed to slotted.

The upper section 46 includes two holes 48 to facilitate attachment to the lower section 42. Rivets 50 or a other fastening devices which are not easily removed secure the upper section 46 to the lower section 42 by penetrating the holes 48 which are aligned with the slotted holes 44. As a result easily manipulation of the storage cylinder fitting 30 by removal of the upper section 46 of the bracket 40 is not possible. However, the upper section 46 of the bracket 40 may be removed by a time-consuming process of drilling out the rivets 50. Bolts may also be used to hold the upper section 46 and lower section 42 together.

The upper section 46 defines an interference surface 54. The interference surface 54 abuts against the midsection 33 or wrench flats of the storage cylinder fitting 30 to prevent rotational movement of the fitting 30. The interference surface 54 may be a single face abutting a single flat portion of the midsection of the fitting 30. Alternatively, the interference surface 54 may be two or more surfaces. As shown in FIGS. 1 and 2 the upper section 46 is a plate and the interference surface 54 is multiple surfaces, defining an aperture, which completely circumscribes the midsection 33 of the fitting 30.

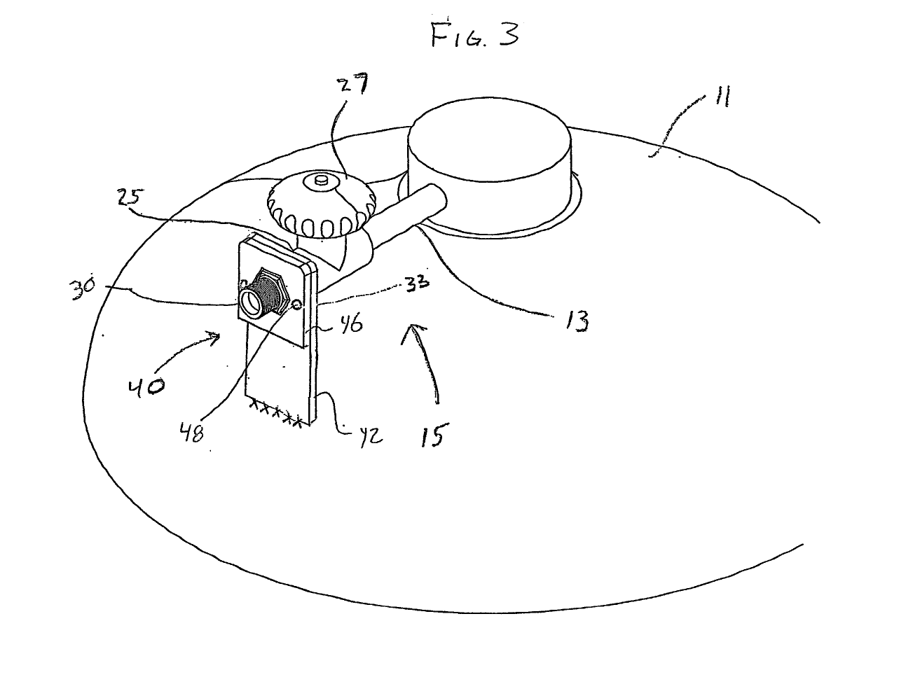

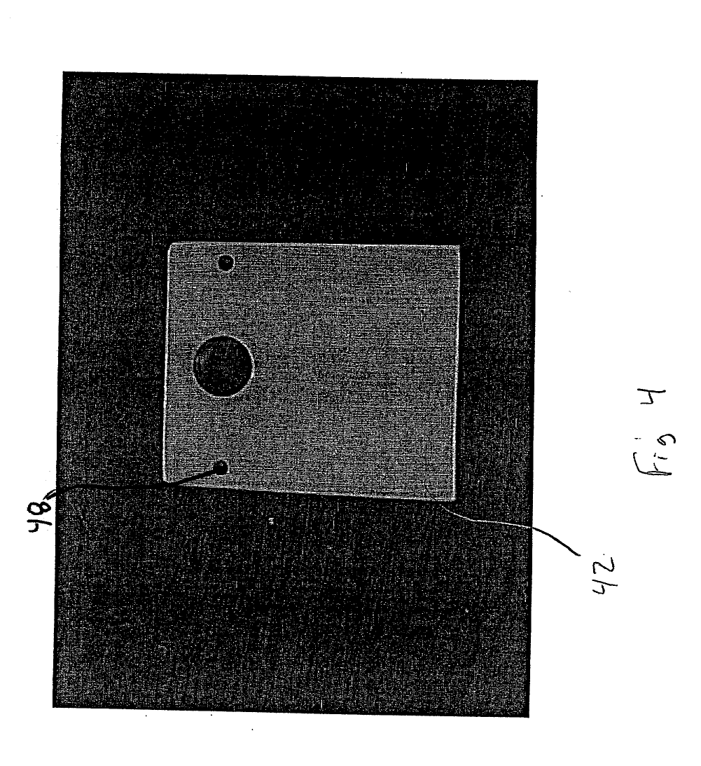

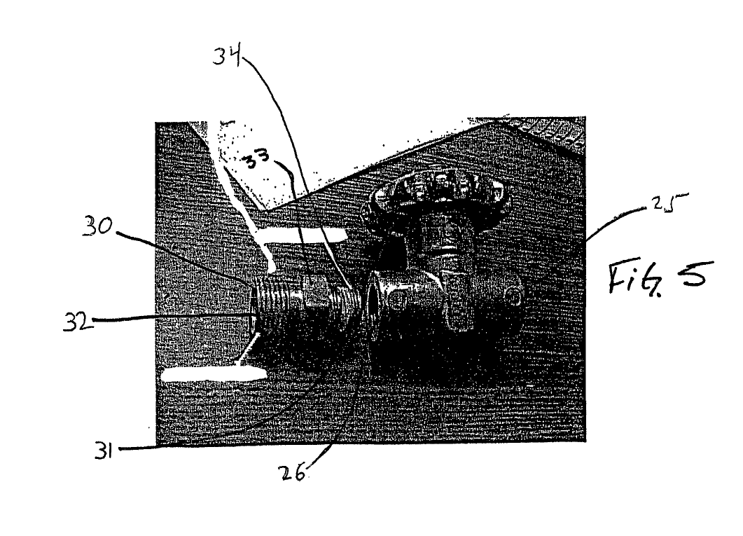

Referring to FIGS. 3 and 4, a variation of the first embodiment is shown where the lower section 42 has an extended height. The upper section 46 is shortened. The lower section 42 defines an aperture which circumscribes the cylinder fitting. The aperture in the lower section does not restrict rotation of the fitting 30. An advantage to this variation is the ability to use a common upper plate in both the first embodiment of the invention and the second embodiment described below.

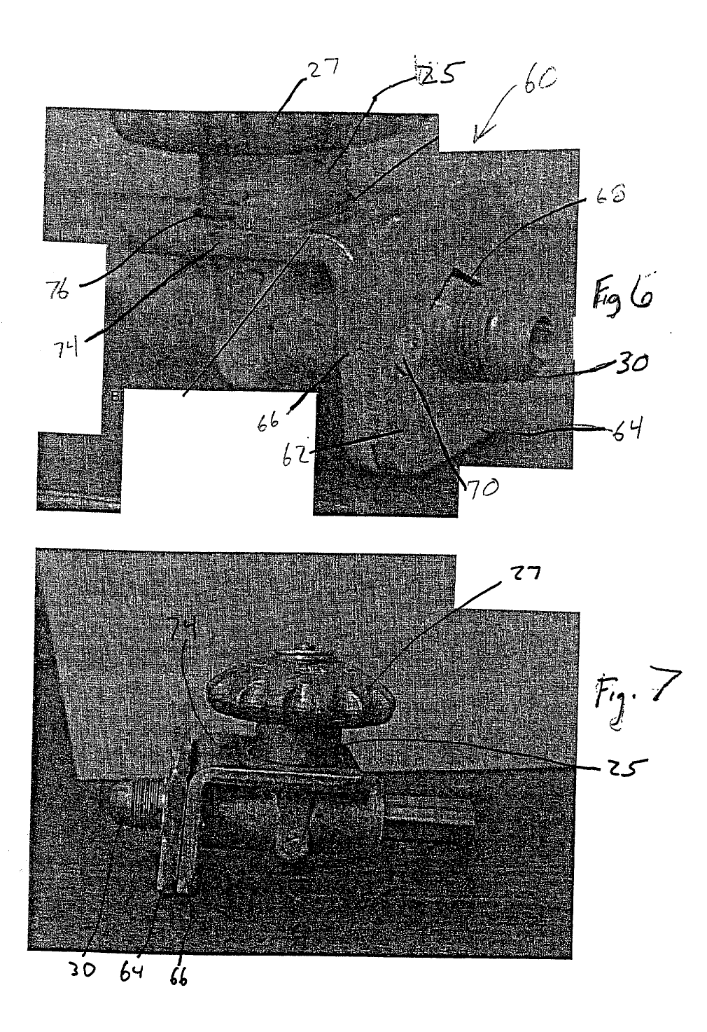

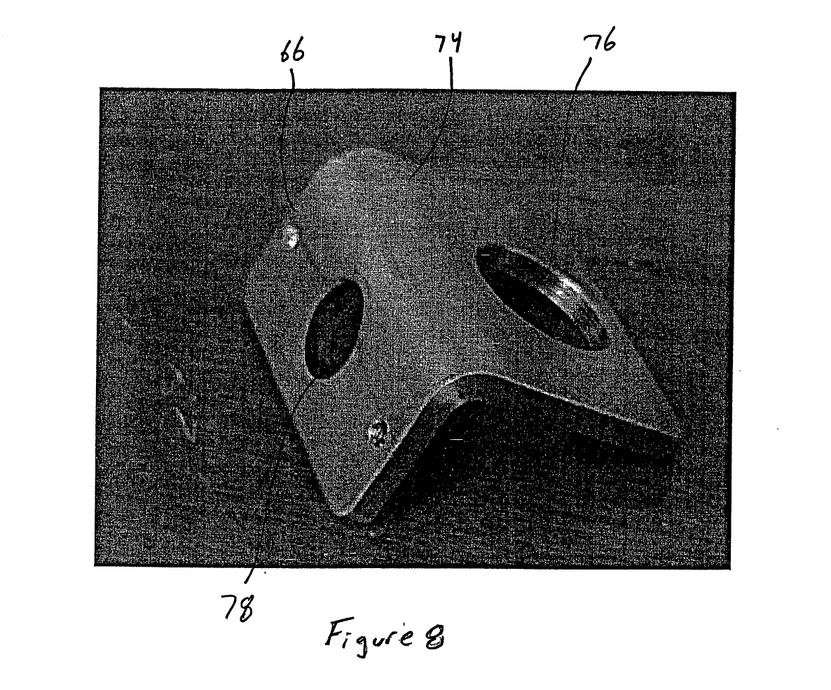

A second embodiment of the bracket 60 is shown in FIGS. 6, 7, 8 and 9. The second embodiment of the bracket 60 does not require attachment to a cylinder itself. The bracket 60 includes a generally vertical section 62 and a generally horizontal section 74. The generally vertical section comprises two vertical plates, an exterior plate 64 and an interior plate 66. The exterior plate 64 and interior plate 66 may have substantially equal heights and widths. The exterior plate 64 includes one or more interference surfaces 68, similar to those in the first embodiment of the bracket. These surface(s) 68 prevent rotational movement of the fitting 30. The exterior plate 64 abuts and is attached to the interior plate 66. The interior plate defines an aperture 78 through which the fitting 30 may pass, but does not interfere with the rotational movement of the fitting 30. The interior plate 66 is attached to the exterior plate 64 using a locking device which is difficult to remove such as rivets 70 or a lock. As a result, lateral movement of the vertical section 62 is restrained. It is difficult for an unauthorized person to detach the exterior plate 64 and manipulate or remove the fitting 30. If rotation of the fitting 30 is not prevented, the fitting 30 may leak and result in lost product. However, it is possible to remove the exterior plate 64 by drilling out the rivets 70 or unlocking the lock. As shown in FIG. 7, the interior plate 66 may be positioned along the lengthwise axis of the piping connection in a position which is beyond the valve body. Thus, upon removal of the exterior plate 64, unscrewing the fitting 30, and removal of the handle 27 the interior plate 66 and horizontal section 74 can be easily removed. The interior plate 66 may be part of a common piece which includes the horizontal section 74.

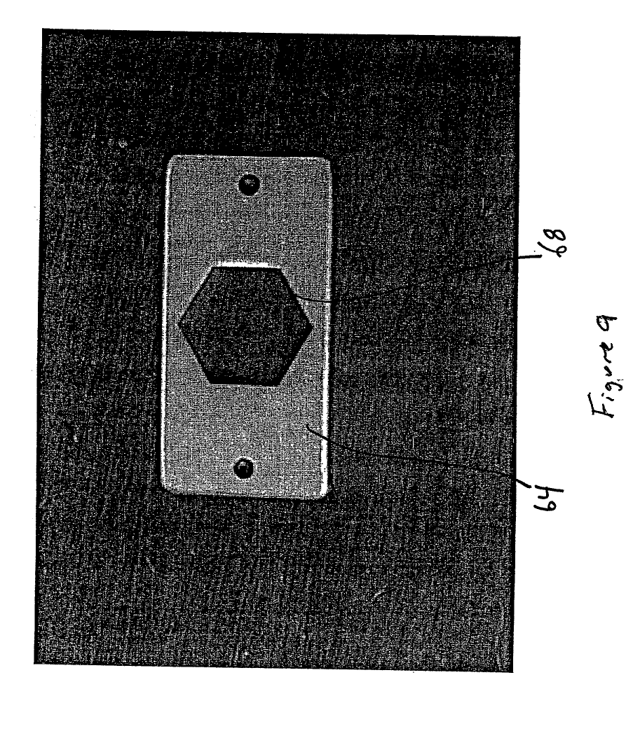

Referring to FIGS. 7 and 8, the horizontal section 74 of the bracket 60 defines an opening 76 through which the valve body 25 may protrude before a handle 27 is attached to the valve body 25. In an embodiment of the invention the horizontal section 74 fully circumscribes the valve body 25. The interference caused by the horizontal section 74 against the valve body 25, in combination with the means of locking the bracket 60 results in a system which cannot be easily disengaged from the valve 25. As a result this bracket 60 prevents fitting 30 removal in addition to locking the fitting 30 in place and preventing rotation.

1. A bracket for preventing undesired movement of a storage cylinder fitting comprising:
a lower section permanently mounted to a storage cylinder;
an upper section affixed to said lower section;
said upper section defining an interference surface for abutting against the storage cylinder fitting to prevent rotational movement thereof.

2. The bracket assembly according to claim 1 wherein said lower section is affixed to said upper section using rivets.

3. The bracket assembly according to claim 1 wherein said lower section defines an aperture which circumscribes the cylinder fitting.

4. The bracket assembly according to claim 1 wherein said upper section comprises a plate which defines an aperture and multiple interference surfaces.

5. The bracket assembly according to claim 4 wherein said interference surfaces form a hexagon shape.

6. A bracket for preventing undesired manipulation of a storage cylinder fitting attached to a storage cylinder valve, said bracket comprising:
a horizontal section defining an opening through which a valve body of the storage cylinder valve extends;
a vertical section including an interference surface for abutting against the storage cylinder fitting to prevent rotational movement thereof; and
locking means for restraining lateral movement of the vertical section.

7. The bracket according to claim 6 wherein said locking means are rivets.

8. The bracket according to claim 6 wherein said horizontal section circumscribes the valve body.

9. A bracket for preventing undesired manipulation of a storage cylinder fitting attached to a storage cylinder valve, said bracket comprising:
a vertical section including an exterior plate and an interior plate and means for attaching said exterior plate to said interior plate, said exterior plate including an interference surface for abutting against the storage cylinder fitting to prevent rotational movement thereof, and
a horizontal section integrally formed with said interior plate wherein said horizontal section circumscribes a valve body of the storage cylinder valve.

10. The bracket of claim 9 wherein said interference surface resists the rotational movement of wrench flats upon the storage cylinder fitting.

11. The bracket of claim 9 wherein said interior plate is axially positioned beyond said valve body and circumscribes said storage cylinder fitting.

12. The bracket of claim 9 wherein said exterior plate and said interior plate are joined with two rivets.

13. The bracket of claim 9 wherein said exterior plate defines an aperture and multiple interference surfaces.

14. The bracket of claim 9 wherein said exterior plate and said interior plate have substantially equal heights and widths.
